(19) United States
(12) Patent Application Publication
(10) Pub. No.: US 2008/0102687 A1
(43) Pub. Date: May 1, 2008

(54) Category 6 high frequency 110 block

(76) Inventor: Zheng-Ron Tsou, Taoyung (TW)

Correspondence Address: NATH & ASSOCIATES PLLC, 112 South West Street, Alexandria, VA, 22314, US

(21) Appl. No.: 11/589,098

(22) Filed: Oct. 30, 2006

(51) Int. Cl. H01R 4/24

(52) U.S. Cl. 439/404

(57) ABSTRACT

The invention relates to a category 6 high frequency 110 block, which is satisfied with the category 6 (CAT-6) standard of communication, comprising mainly terminals, fore cover, block housing, plastic nub, acting nub, rear cover etc. By placing a plastic nub on one end of acting nub, then the big and small cylinders are aimed on the big and small hole of acting nub and insert together and fix, the invention configures the assembled acting nub from right side into blocking housing which has localization cylinder surface. The terminal set and the acting nub form a circuit to counterbalance the disrupting signals. Thus the normal signal will be transferred with high quality, improving the efficiency of high speed transmit of information.

### FIELD OF THE INVENTION

The present invention relates to a category 6 high frequency 110 block and more particularly relates to the structure of the block so as to provide a more reliable high-speed transmission efficiency.

### BACKGROUND OF THE DISCLOSURE

Category 5 high-frequency block known in the art is assembled as follows, please refer FIG. 1, FIG. 2 and FIG. 21. The terminals (21) of the first pair (11) to the fourth pair (14) are inserted into blocking housing (23), then fixed in left inside of blocking housing by way of fore cover (22) to reach the purpose of connecting wire on both end of terminals. To meet the standard of category 6, there are methods which would increase the distances (26) of pair and incorporate isolate grounding slice (25) (as shown in FIG. 22). Alternately, methods of balancing cross-talk by increasing the length (28) and the width (27) of the commonly using block which is shown in FIG. 21, or changing the position of pairs, make a wider distance between the pairs. Therefore the width of the block (29) is wider than that of commonly used block as shown in FIG. 21. However these two methods wherein the assembly position of terminals are different from that of category 5, so there is no way to be compatible forward. But the invention does not change the position of terminals and would be compatible forward.

### SUMMARY OF THE DISCLOSURE

In view of this, the inventor by years-experience had developed a new design which is a category 6 high frequency block and acting nub and plastic nub are placed inside. There are effect counterpoises between the two contiguous pairs by placing acting nub and plastic nub inside block housing. Thus increase the stability of signals while transmitting, reduce the interference of the noise and cross-talk etc. During effect balancing signal transmission is over the communication standard of category 6 of TIA/EIA 568B.2-1. Thus the present invention provides a high frequency block having an acting nub wherein the foot of lower end of the acting nub is assembled into the plastics nub, the acting nubs are planted into the right side, the left side and top side of the block housing, separately. Thus makes the acting nub contact with terminal pair.

Devices according to the present invention of category 6 high frequency 110 block include an insert of acting nub from the right side, or form the left side, or from the upside of block housing into the block housing. It is customized or designed to meet the demand of manufacturer to choose the insert position, easily assembled and with high mobility. A set of acting nubs can be inserted into blocking housing at one time, save the man-hour and reduce the cost. The present invention has a simple configure with high practicability, which improves the ability of communication, increases the utilization benefit of the products.

### BRIEF DESCRIPTION OF THE DRAWINGS

FIG. 1 is an exploded perspective view of a well-known block

FIG. 2 is view from 4 directions of a well-known block after assembled.

FIG. 3 is exploded perspective view and assembly view of the block in accordance with the present invention.

FIG. 4 is front view and top view of the block in accordance with the present invention.

FIG. 5 is stereogram of the block in accordance with the present invention.

FIG. 6 is stereogram of fore cap in accordance with the present invention.

FIG. 7 is view of three phases of fore cap in accordance with the present invention.

FIG. 8 is view of four phases of block housing in accordance with the present invention.

FIG. 9 is stereogram of block housing in accordance with the present invention.

FIG. 10 is view of three phases of acting nub in accordance with the present invention.

FIG. 11 is view of three phases and stereogram of plastic nub in accordance with the present invention.

FIG. 12 is front view and top view of acting nub and plastic nub after assembling in accordance with the present invention.

FIG. 13 is view of three phases and stereogram of rear cap in accordance with the present invention.

FIG. 14 is stereogram of acting nub, plastic nub, and rear cap after assembling in accordance with the present invention.

FIG. 15 is sectional view of acting nub, plastic nub, and terminal pair.

FIG. 16 is an exploded perspective view of another embodiment of present invention.

FIG. 17 is view of three phases and stereogram of another acting nub of present invention.

FIG. 18 is perspective view and top view of another acting nub and plastic nub after assembling in accordance with present invention.

FIG. 19 is stereogram of another acting nub, plastic nub, and fore cap after assembling in accordance with the present invention.

FIG. 20 is an exploded perspective view of another embodiment of present invention.

FIG. 21 is sectional view of inside arrangement of a well-known terminal pair.

FIG. 22 is sectional view of increasing distance between pair and incorporating isolate grounding slice that is well known by skill in the art.

FIG. 23 is sectional view of changing location of pair in order to balancing interference that is well known by skill in the art.

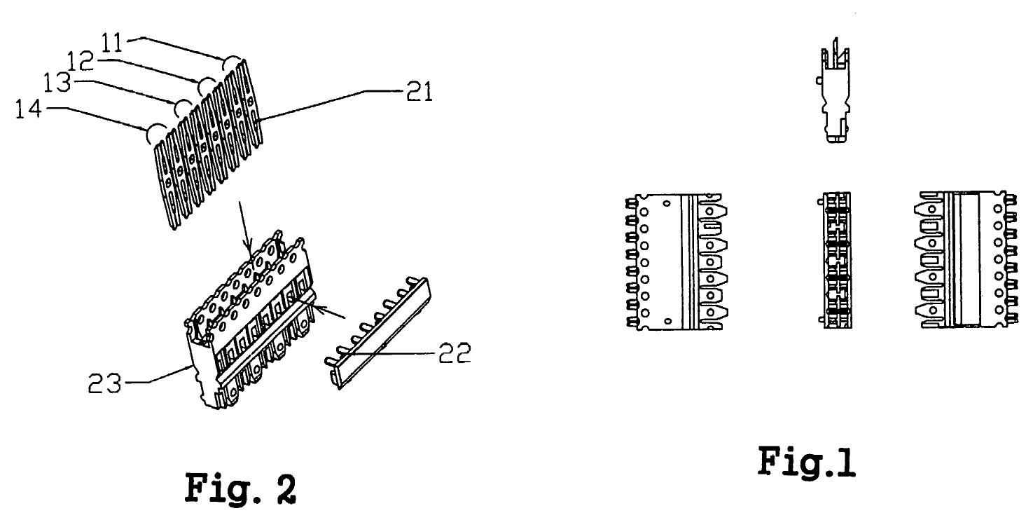

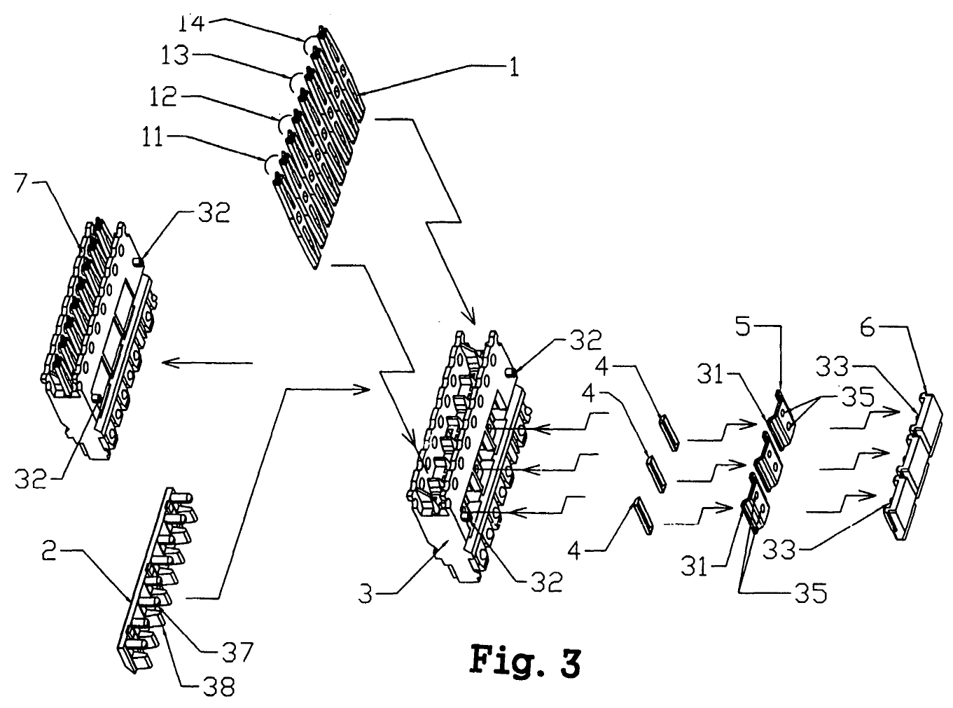

### DETAILED DESCRIPTIONS OF PREFERRED EMBODIMENT(S):

The typical representation of present invention is shown in FIG. 3. Brief identification of the elements of FIG. 3 is as follows:

| | | | |
|---|---|---|---|
| 1 | Terminal | 2 | Fore cap |
| 1 | Terminal | 2 | Fore cap |
| 3 | Block housing | 4 | Plastic nub |
| 5 | Acting nub | 6 | Rear cap |
| 7 | Category 6 high frequency 110 block | 11 | First pair |
| 12 | Second pair | 13 | Third pair |
| 14 | Fourth pair | 32 | Localization cylinder |
| 33 | Cylinder | 35 | Hole |
| 37 | Protruding cylinder | 38 | Plastic side wall |

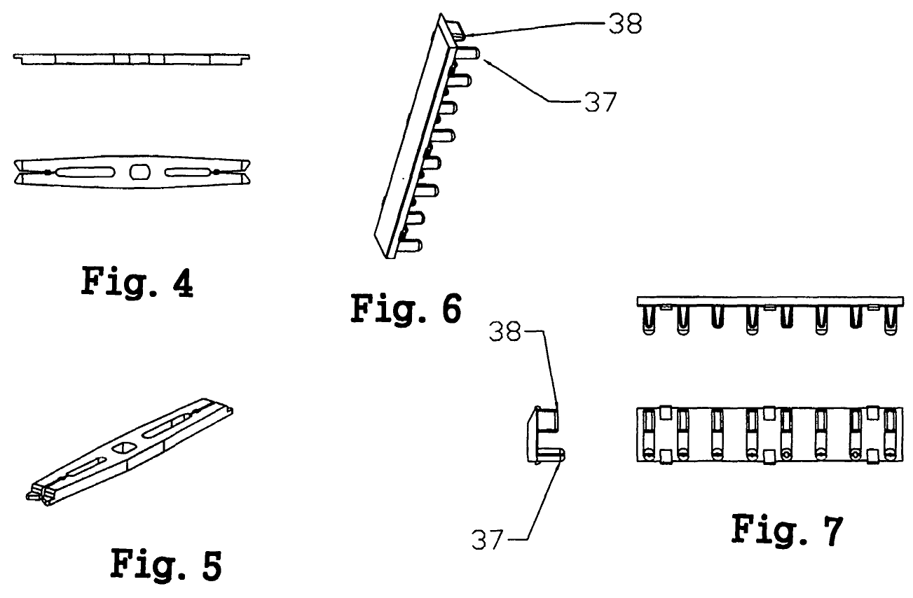

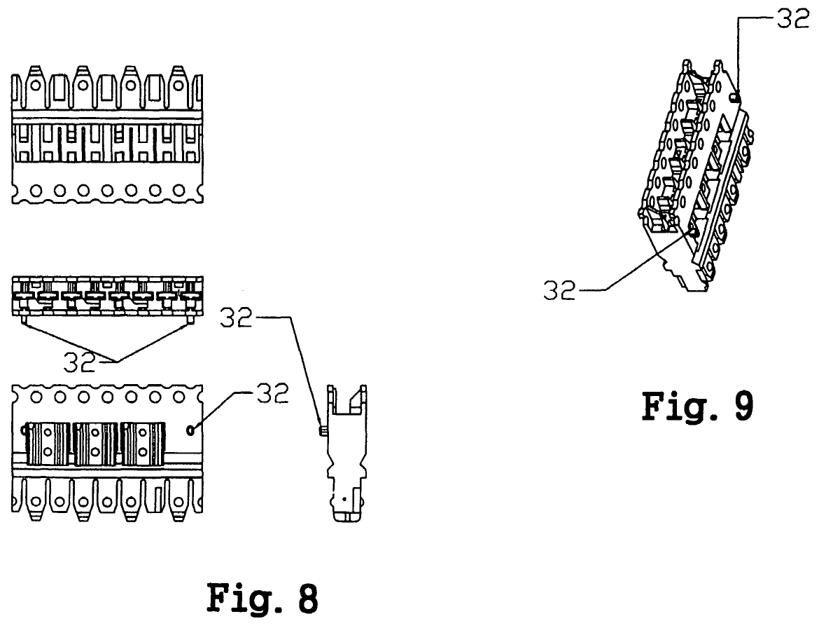

The present invention relates to a Category 6 high frequency 110 block (7), wherein mainly includes elements of terminals (1), fore cap (2), block housing(3), plastic nub (4), acting nub (5), rear cap (6) etc. Please refer to FIG. 3 the terminals are made of metal by pressing to form the shape as shown in FIG. 4 and FIG. 5. Terminal (1) and terminal (1) are coupled together to make an pair. The present invention comprises a first pair (11), the second pair (12), the third pair (13) and the fourth pair (14). The fore cap (2) is made of plastic material and integrated as a whole by shooting machine to form the shape. As shown in FIG. 6 and FIG. 7, each interval is separated by protruding cylinder (37) and plastic side wall (38), then the space is divided into different areas. The block housing (3) is also made of plastic material and integrated as a whole. Inside of block housing has space for terminal (1), pair, fore cap (2), plastic nub (4), acting nub (5), and rear cap (6). One side of the block housing (3) consists of two localization cylinders (32) which are protuberant.

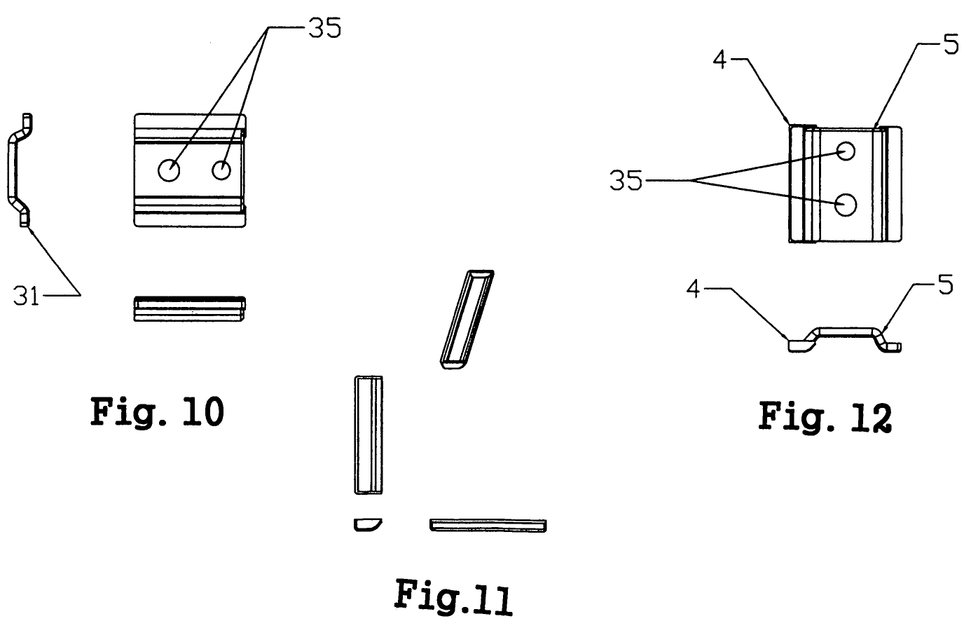

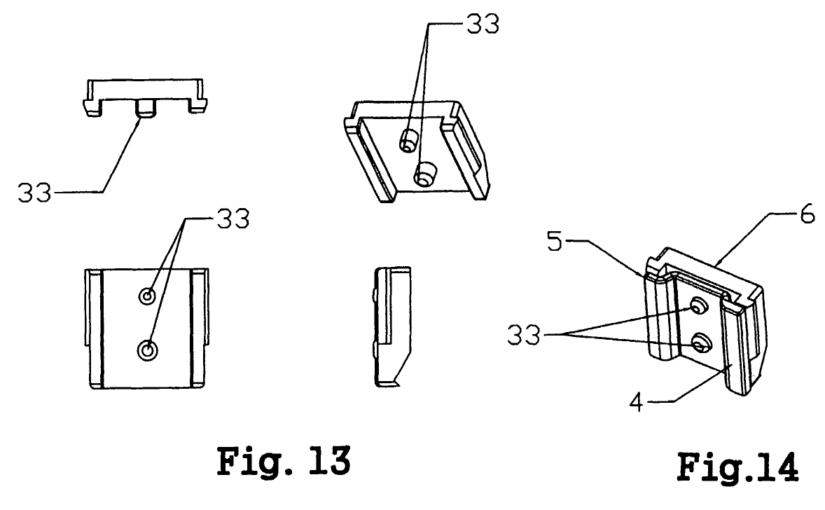

The plastic nub (4) has a groove inside, the bottom of outside forms a declining hypotenuse in one corner as shown in FIG. 11. Acting nub (5) is made of metal and bent and pressed into a shape which is integrated as whole, please refer to FIG. 10, the bottom of both sides are not on the same horizontal place after bending. One side of acting nub has a relatively lower deck (31) than the other side. In the middle portion of acting nub (5) at different locations there are two holes (35) which are formed by pressing. The rear cap (6) is made of plastic material by shooting from the shooting machine to form a shape as integrated as whole. The shape is shown in FIG. 13. In the middle portion of rear cap (6) at different locations there are two cylinders (33).

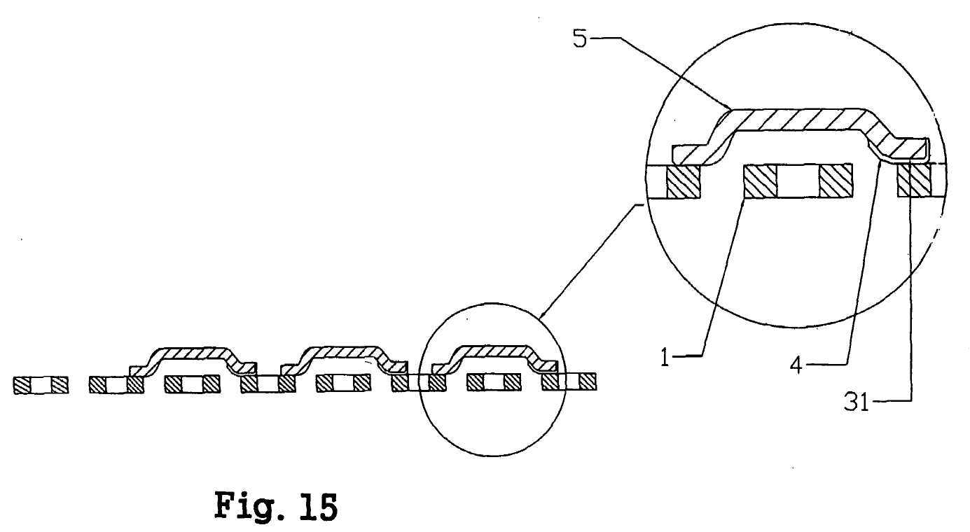

The first pair (11), the second pair (12), the third pair (13) and the fourth pair (14) are consisted of terminals (1). These pairs are inserted into block housing from upside of block housing at one time. The relatively lower decks (31) of each acting nub in the pack of acting nubs (5) are assembled into plastic nub (4) as shown in FIG. 12. Then aim the holes (35) of acting nub (5) with the cylinders (33) of rear cap (6) and put into the holes as shown in FIG. 14. The component composed of plastic nub (4), the acting nub (5) and rear cap (6) is placed onto a surface which is formed by localization cylinder (32), insert from the right side of block housing (3). Finally insert the fore cap (2) from the left side of block housing (3). The acting nubs (5), plastic nub (4), and pair of terminals according to the present invention of category 6 high frequency block are described in FIG. 15. After the plastic nub (4) is assembled with the relatively lower deck (31) of the acting nub (5), both sides of acting nub are on the same horizontal level. Therefore inside the block housing (3) the acting nub (5) and plastic nub (4) would reduce interference of crosstalk between pair of terminals effectively through the effect-counterpoise of TT or RR. Thus improve the quality of transmission and ability of communication.

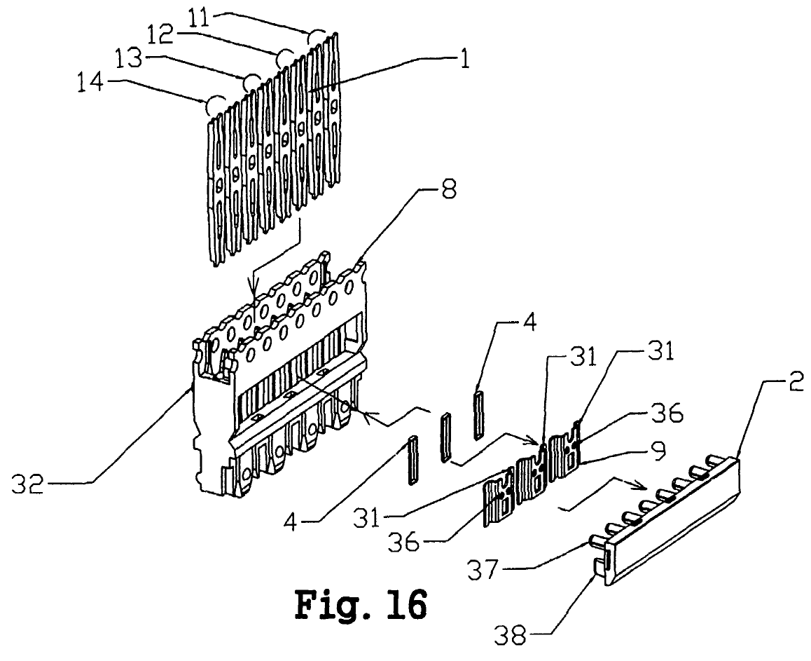

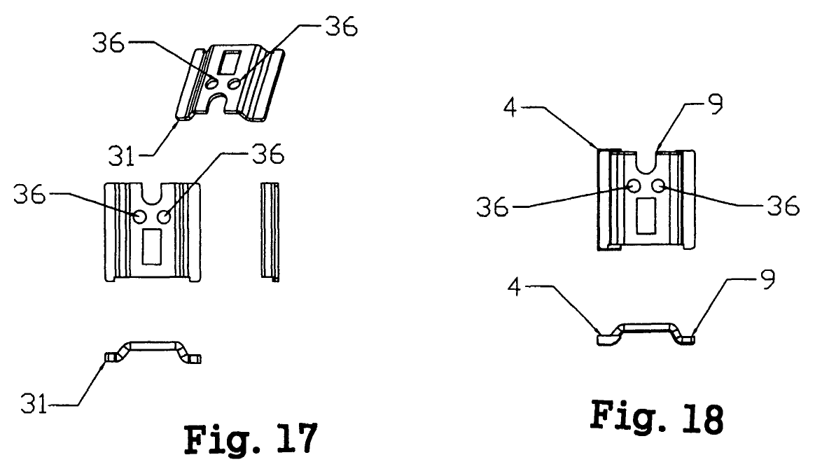

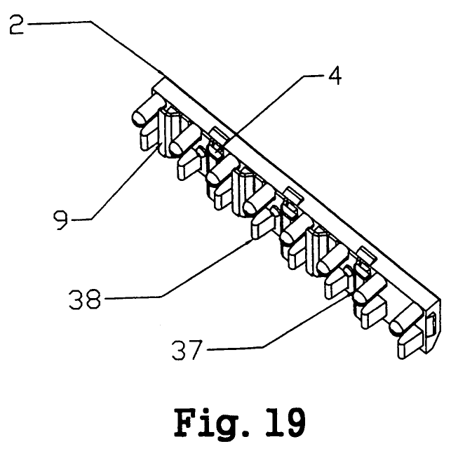

Another preferred embodiment of present invention of category 6 high frequency 110 block, the acting nub (9) is inserted into block housing (8) from the left side of block housing (8). As illustrated in FIG. 16, the first pair (11), the second pair (12), the third pair (13) and the fourth pair (14) are consisted of terminals (1). They are inserted into block housing from upside at one time. In the middle portion of acting nub (5) there are two round holes (36) with the same size and different position, an oval-shape opening, and rectangle hole all made by pressing as shown in FIG. 17. The relatively lower decks (31) of each acting nub of pack of acting nub (9) are assembled with the plastic nub (4) as shown in FIG. 18. Then insert the protruding cylinders (37) of fore cap (2) and plastic side wall (38) into the acting nub (9) as illustrated in FIG. 19. Finally place the component consisted of plastic nub (4), acting nub (9) and fore cap (2), into the block housing (8) from left side of block housing.

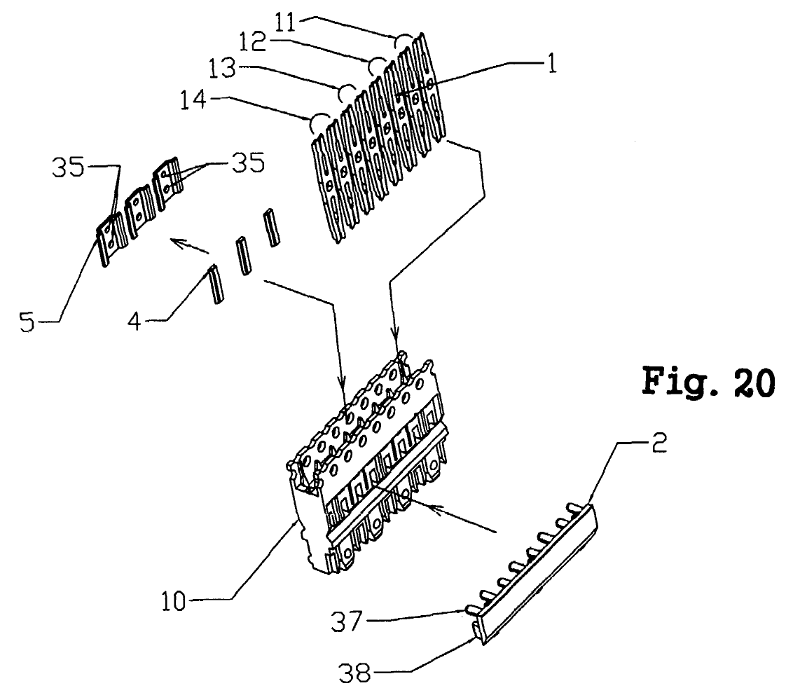

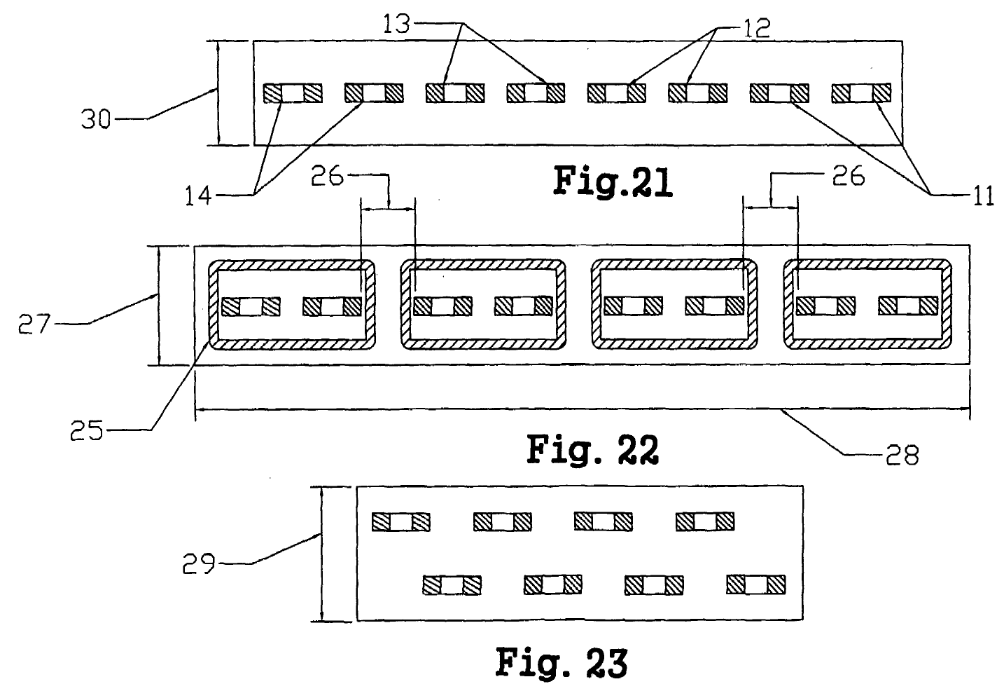

Another preferred embodiment of present invention of category 6 high frequency 110 block, the acting nub (5) is inserted into block housing (10) from the up side of block housing (10). Please refer to FIG. 20, the first pair (11), the second pair (12), the third pair (13) and the fourth pair (14) is comprised of terminals (1). They are inserted into block housing (10) from upside at one time. The relatively lower decks (31) of each acting nub of pack of acting nub (5) are assembled with the plastic nub (4). Then place into block housing (10) from the up side of block housing (10). Finally place the fore cap (2) into the block housing (10) from left side of block housing.

The data from the present invention is analyzed through HP8753E high frequency network analyzer. The results are shown in Appendix 1 wherein comprising substantive data of near end crosstalk (NEXT). It is known by the enclosure: before improvement the first-second pair at frequency of 250 MHz, the value of NEXT is −41.62 dB; at frequency of 200 MHz, the value of NEXT is −43.66 dB; at frequency of 100 MHz, the value of NEXT is −49.71 dB; at frequency of 10 MHz, the value of NEXT is −71.20 dB. Before improvement the second-third pair at frequency of 250 MHz, the value of NEXT is −40.22 dB; at frequency of 200 MHz, the value of NEXT is −42.30 dB; at frequency of 100 MHz, the value of NEXT is −47.92 dB; at frequency of 10 MHz, the value of NEXT is −61.10 dB. Before improvement the third-fourth pair at frequency of 250 MHz, the value of NEXT is −41.20 dB; at frequency of 200 MHz, the value of NEXT is −43.42 dB; at frequency of 100 MHz, the value of NEXT is −49.52 dB; at frequency of 10 MHZ, the value of NEXT is −69.51 dB.

After improvement the first-second pair at frequency of 250 MHz, the value of NEXT is −48.62 dB; at frequency of 200 MHz, the value of NEXT is −50.56 dB; at frequency of 100 MHz, the value of NEXT is −56.05 dB; at frequency of 10 MHz, the value of NEXT is −78.22 dB. After improvement the second-third pair at frequency of 250 MHz, the value of NEXT is −49.21 dB; at frequency of 200 MHz, the value of NEXT is −50.92 dB; at frequency of 100 MHz, the value of NEXT is −56.22 dB; at frequency of 10 MHz, the value of NEXT is −79.12 dB. After improvement the third-fourth pair at frequency of 250 MHz, the value of NEXT is 48.72 dB; at frequency of 200 MHz; the value of NEXT is −49.66 dB; at frequency of 100 MHz, the value of NEXT is −56.91 dB; at frequency of 10 MHz, the value of NEXT is −78.43 dB. Compare the data mentioned above with the value of NEXT in Category 6 table. The later shows the value of NEXT as follows: when frequency is 250 MHz, NEXT value is −46.0 dB; frequency is 200 MHz, NEXT value is −48.0 dB; frequency is 100 MHz, NEXT value is −54.0 dB; frequency is 10 MHz, NEXT value is −74.0 dB. Before improvement the first-second, the second-third, and the third-fourth pair do not meet the requirement of frequency and NEXT value accord with 6 Category 6, however after improvement the first-second, the second-third, and the third-fourth pair do forereach the standard of Category 6.

The counterpoise function of acting nub (5), (9) and plastic nub (4) according to Category 6 high frequency 110 block mentioned above would dispel the mutual interference of signals from close-by pair, thus prevents appearance of crosstalk and interference. In sum, the embodiments mentioned above are only representations of invention, not limitation. Any variations, modifications and applications thereto made by the person skilled in the art would not depart from the spirit and scope of the invention as defined by the appended claims. The disclosed invention of Category 6 high frequency 110 block has been described with respect to preferred embodiments, and achieves the requirement of new-type patent in accordance with the law.

Appendix 1, attached hereto and made a part hereof, is a table shows frequency and crosstalk data of pair to pair in a block before and after improvement.

NAMES OF ELEMENTS IN THE FIGURES

| | | | |
|---|---|---|---|
| 1 | Terminal | 2 | Fore cap |
| 3 | Block housing | 4 | Plastic nub |
| 5 | Acting nub | 6 | Rear cap |
| 7 | Category 6 high frequency 110 block | 8 | Block housing |
| 9 | Acting nub | 10 | Block housing |
| 11 | First pair | 12 | Second pair |
| 13 | Third pair | 14 | Fourth pair |
| 21 | Terminal | 22 | Fore cap |
| 23 | Terminal | 25 | Isolate grounding slice |
| 26 | Distance between pair | 27 | Width of block |
| 28 | Length of block | 29 | Width of block |
| 30 | Width of block | 31 | Relatively lower |
| | | | deck of acting nub |
| 32 | Localization cylinder | 33 | Cylinder |
| 35 | Hole | 36 | Hole |
| 37 | Protruding cylinder | 38 | Plastic side wall |

What is claimed is:

1. A Category 6 high frequency 110 block, comprising:
a plurality of pairs of terminals;
a block housing into which said first, second, third and fourth pair of terminals are inserted from upside of block housing at one time;
a nub;
a set of a plurality of acting nubs, the relatively lower decks of each acting nub in the set of acting nubs are assembled into said nub;
a rear cap affixed to said acting nub;
said nub, acting nub, and rear cap being located from a side of said block housing into it which it fitted; and
a fore cap located on the other side of said block housing.

2. A Category 6 high frequency 110 block as recited in claim 1, wherein said terminals are made of metal material through pressing, and said terminals are constituted into pairs.

3. A Category 6 high frequency 110 block as recited in claim 1, wherein the fore cap is made of a plastic material by a shooting machine through shooting to be integrated as whole; and each interval is separated by a protruding cylinder and a plastic side wall, and then the space is divided into different areas.

4. A Category 6 high frequency 110 block as recited in claim 1, wherein the block housing is made of plastic material and integrated as a whole; wherein said block housing has an inside and on said inside of said block housing there is space for said terminal pairs, fore cap, plastic nub, acting nub, and rear cap and wherein one side of said block housing has two localization cylinders which are protuberant.

5. A Category 6 high frequency 110 block as recited in claim 1, wherein the acting nub is made of metal and bent and pressed into a shape which is integrated as whole;
the bottoms of both sides are not on the same horizontal place after bending; one side of said acting nub has a relatively lower deck than the other side, and wherein a middle portion of said acting nub has two holes at different locations which are formed by pressing.

6. A Category 6 high frequency 110 block as recited in claim 1, wherein the plastic nub has a groove inside which is used to be assembled with the relatively lower deck of acting nub such that after assembling both sides of acting nub are in the same horizontal place accounting for there is only one plastic nub in acting nub. Such configure is a characteristic.

7. A Category 6 high frequency 110 block as recited in claim 1, wherein the bottom of outside plastic nub forms a declining hypotenuse in one corner and in which inside of the hypotenuse after assembled with acting nub is the characteristic.

8. A Category 6 high frequency 110 block as recited in claim 1, wherein in the middle portion of rear cap there are two cylinders at different locations, such that it is a characteristic that there is an alignment of the holes of acting nub with the cylinders of rear cap and put into the holes.

9. A Category 6 high frequency 110 block, mainly comprises elements of terminals, fore cap, block housing, plastic nub, acting nub and a protruding cylinder; wherein:
A first pair, second pair, third pair, and fourth pair of terminals are inserted at one time into said block housing from upside of block housing;
said acting nubs having a relatively lower decks of each acting nub in the set of acting nubs are assembled into plastic nub;
said protruding cylinder formed by said fore cap and plastic side wall are inserted into acting nub; and
a component comprised of said plastic nub, said acting nub, and said fore cap is inserted from the left side of block housing into it.

10. A Category 6 high frequency 110 block as recited in claim 9, wherein the middle portion of said acting nub has two holes with the same size and different positions, an oval-shaped opening, and a rectangle hole;
An upper deck and a lower deck which are not at the same level, and are located on opposite sides of said acting nub;
said plastic nub is assembled on the relatively lower deck of acting nub, and each acting nub has only one plastic nub to mount, wherein after assembling both sides of said acting nub would be in even level.

11. A Category 6 high frequency 110 block as recited in claim 9, wherein the protruding cylinders formed from fore cap and plastic side wall are inserted into the oval-shape opening and rectangle hole of acting nub.

12. A Method of Assembling a Category 6 high frequency 110 block comprising:
inserting an acting nub into a block housing from the up side of block housing;
inserting a first, second, third and fourth pair of terminals into said block housing from upside at one time such that a relatively lower deck of each acting nub in the pack of acting nub are assembled with the plastic nub;
then placing the facture into said block housing from the up side of block housing; and
finally placing said fore cap into said block housing from the left side of said block housing.
